(19) United States
(12) Patent Application Publication
(10) Pub. No.: US 2003/0146972 A1
(43) Pub. Date: Aug. 7, 2003

(54) Monitoring system

(76) Inventor: Karl-Erik Morander, Goteborg (SE)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/239,255

(22) PCT Filed: Mar. 20, 2001
(86) PCT No.: PCT/SE01/00587

(30) Foreign Application Priority Data
Mar. 20, 2000 (SE) 0000925-8

(51) Int. Cl. H04N 15/00

(52) U.S. Cl. 348/46; 348/136; 382/154

(57) ABSTRACT

The invention relates to a monitoring system (10, 20) for monitoring of at least a fixed but displaceable object in a volume, which object is provided with at least a marking means (13, 13a-13d, 23) in form of a light generating or reflecting device, which system at least comprises an optical recording unit (11, 21) for recording of an image of at least a part of the volume comprising said object provided with the marking means (13, 13a-13d, 23), device for transformation of said image to a digital representation of the same image, means (14) for comparison of the digital representation to a stored data-set, and device for generating a signal at the presence of a deviation at comparison of the digital representation to the stored data-set. The data-set stored at least comprises a two-dimensional stationary coordinate value for the initial position of the marking means (13, 13a-13d), that the system comprises means for extracting at least a stationary coordinate value, which is at least a two-dimensional coordinate value, out of the digital representation for the marking means, whereby said comparison means (14) compares said extracted two dimensional coordinate value to the stored stationary coordinate value.

### TECHNICAL AREA

The present invention relates to a monitoring system for monitoring at least a fixed but displaceable object in a volume, which object is provided with at least one marking means in form of a light generating or light reflecting device, which system comprises at least one optical recording unit for recording an image of at least a part of the volume comprising said object provided with the marking means, device for transforming said image to a digital representation of the same image, means for comparison of the digital representation with a stored data-set, and device for generating a signal at the presence of a deviation at comparison of the digital representation with the stored information quantity.

### DESCRIPTION OF STATE OF THE ART

For monitoring of substantially articles of value in spaces such as rooms, stores, museums and so on, fixed alarm connections or so-called border watch are usually used.

With fixed alarm connections means such systems where each object is provided with an alarm sensor, which via a cable is connected to a central alarm unit. The disadvantage of such systems is that cables must be arranged to each object to be monitored, which makes the system less flexible.

In border watch system, each object is provided with active or passive sensors, which can alarm when a guarded point is trespassed. The disadvantage of such systems is that damage on an alarmed object cannot be detected immediately, which among others can result in time for manipulation of the alarm sensors.

There are also systems comprising passive/active transponders attached to the object to be guarded. The transponders are continuously or periodically in radio communication with a controlling unit, which generates an alarm when a boarder is trespassed or an attempt is made to manipulate the transponder. The drawbacks of such systems are that they are usually expensive, for instance because the transponders, complicated monitoring algorithms for several transponders, they do not detect displacements within the controlled area, the need of frequency band for operation and risk of radio interferences.

In the Swedish patent application No. 9700065-7, a method for calculating the central point for a marker in a motion analysis system is known.

JP 11 003 474 relates to deciding the changes of the image of a monitored object by means of a reflected laser light from the monitored object and generating an alarm. Accordingly, a pattern corresponded to the incoming image, is compared with a stored pattern.

In JP 11185175, it is decided whether the image of a marker has been changed or not, whereby an inputted image is compared to a stored image.

Moreover, EP 393 807 relates to image processing, see for instance claim 1. An image of a marker is compared to a stored image and variations in the image edge are registered.

According to EP 984 412 signals from an image, or parts of an image, are continuously compared to a stored reference image, whereby correlation analysis is used. When differences are detected in the correlated signal a warning or alarm is generated.

Also, WO 98/56182, U.S. Pat. No. 4,160,998, U.S. Pat. No. 5,880,775, DE 4417128 and DE 38 42 356 relate to image processing, where alarm is generated when frequent differences in the form of the images are detected.

The present invention relates to monitoring of a position of a marker, particularly its coordinates in two dimensions, and registering the deviation from a stationary position coordinate. The changes of the form of the marker and the appearance are unimportant, since the coordinates are decided by means of a center of gravity or center point.

However, FR 2759541 mentions the use of coordinates. Thus, the system relates to motion analysis, in which the motion of the markers are analyzed and if its motion pattern deviates from a motion-determined pattern, an alarm is generated.

### BRIEF DESCRIPTION OF THE INVENTION

The object of the present invention is to provide a system for substantially automatically, contactless and optical monitoring of a volume and/or a number of objects in a volume by means of simple means, substantially in real time without the need for complicated modifications within the volume or the object.

Another object of the present invention is to provide a simple but yet efficient thief-proof protection system.

Yet, another object of the invention is to provide a smoke detection system.

These objects have been achieved by means of the initially said system, in which the stored data set comprises at least a two dimensional stationary coordinate value for the initial position of the marking means. The system comprise means for extraction of at least one stationary coordinate value, which is at least a two-dimensional coordinate value, out of the digital representation for the marking means, whereby said comparison means compares said extracted two dimensional coordinate value to the stored stationary coordinate value.

According to a first embodiment, in which the system is used, for instance as a thief-protection a number of objects are provided with said marking means, where the objects are monitored for uncontrolled displacement.

Preferably, each object is provided with a reflecting mark. In another embodiment, a part of the object can be used as a marking means. For obtaining a good protection, several marking means are arranged on the same object.

Preferably, the digital representation contains coordinate values for the marking means and that the stored data set comprises an initial position for the coordinate values of the marking means.

In a system for smoke detection, the light intensity of the marking means is measured and the data set stored comprises an initial light intensity.

Preferably, the system comprises a heat detector.

The invention also relates to a method for monitoring an object in a volume provided with at least one marking means in form of a light generating or light representing device, whereby the method comprises the steps: to arrange at least an optical detector unit for recording an image of at least a part of the volume comprising said marking means, to transform said image to a digital presentation of the same image, compare the digital representation with a stored data-set. Moreover, the method also comprises the steps that: to extract at least one coordinate value, which is at least a two dimensional coordinates value, out of the digital representation of the marking means, compare said extracted two dimensional coordinate valve with a stored stationary coordinate value for said marking means by means of said comparison means, and generate a signal at the presence of a deviation at comparison of the extracted coordinate value with the stored coordinate value.

In one embodiment, the data comprises the coordinate values for said marking means. Moreover, in another embodiment the data comprises the value of the light intensity for said marking means.

### BRIEF DESCRIPTION OF THE DRAWINGS

In the following the invention will be described with reference to the embodiments according to enclosed drawings, in which:

FIG. 1 shows very schematically a first embodiment of a monitoring system according to the invention, and

FIG. 2 shows very schematically a second embodiment of a monitoring system according to the invention.

### DESCRIPTION OF PREFERRED EMBODIMENTS

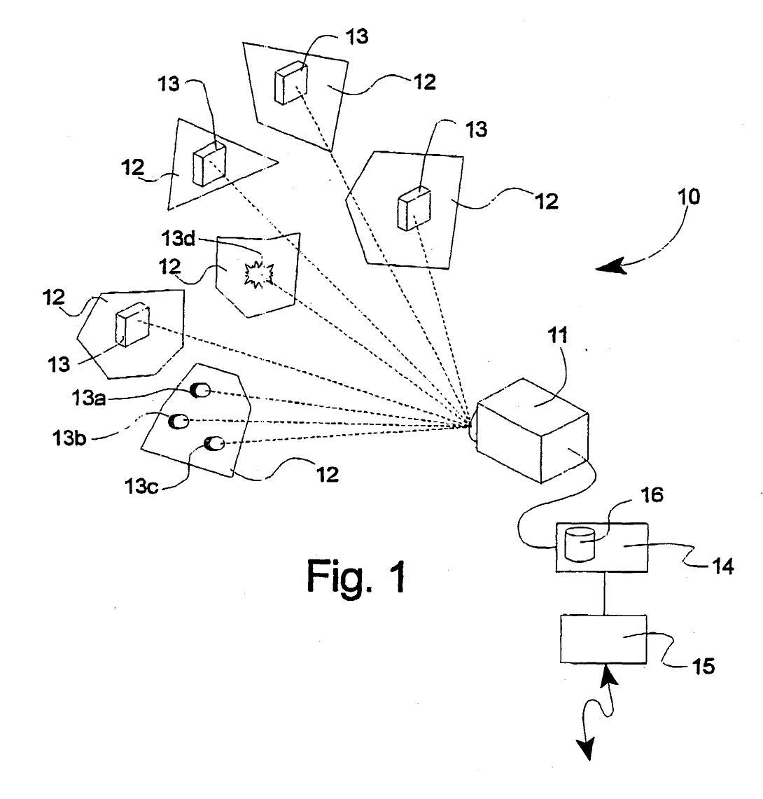

The monitoring system according to the invention consists of a measuring camera system, for instance such a system that can be used for motion analysis. The system 10, which is shown in FIG. 1, comprises at least one camera 11, for monitoring of a number of objects 12 provided with markers 13.

The camera 11 is provided with means, such as a light flash, a lamp or another light source for sending out light, preferably (but not restricted to) infrared light or the like in form of short light flashes. If required, a continuous illumination can be used. Preferably, the markers 13 comprise a retro reflective tape or a body provided with a reflecting surface, which reflects the light back to the camera. Active or passive markers may comprise illumination devices such as light diodes, which are activated by the camera or another control unit can be used.

In communication with the camera 11, or integrated therein, there is a computer unit 14 for receiving image data from the camera, which as a rule is arranged with a CCD-unit (CCD: Charge Coupled Device) or another optical sensor. The data from the sensor unit is preferably obtained in form of digital signals. Recording by means of the sensor, and converting the signal to digital or video signals, are assumed to be well known for a man skilled in the art, and will not be described further herein.

The computer unit 14 evaluates the image of each marker in the field of vision, substantially in real time (image speed 50-240 images/sec) and calculates the coordinates of the markers, preferably to its center (its center of gravity). Preferably, the coordinates are calculated with regard to an interior coordinate system. The coordinate values can have a resolution of 1/50.000 of the field of vision.

The coordinates are continuously transferred, via for instance a serial interface, to a monitoring computer 15. In a memory unit 16 in the computer, the original positions of the markers are stored. All uncontrolled deviation from the original coordinate value of a marker can initiate an alarm. The original positions are registered, for instance by giving a particular command when the objects and the markers have been located on its correct position. If the position is changed, the new positions can be registered in the computer as new original positions.

The number of cameras in the room are chosen so that each marker in the monitored volume is seen by at least one camera. The markers are arranged on objects to be protected and other points of interest in the room (doors, windows, etc). At the start of the monitoring, all the coordinates are stored in the memory unit of the computer 16, which then continuously monitors every change of the coordinates.

Because of the high resolution of the system, a camera having a field of vision of approx 5 m detects a displacement of approx. 0.1 mm. Since the system is passive and has high resolution, it is not possible to interfere the system. Every attempt to manipulate a marker results in that the coordinate values of the marker are changed, which may lead to an alarm. Theoretically, a marker can be displaced from its location in direction towards the camera without the coordinate value is changed, but in practice, this should not be possible to perform. Moreover, several cameras can see a marker and even then, it is not theoretically possible to displace a mark. Of course, the system can be arranged so that it measures the distance between the camera and the mark, such as described in the Swedish patent No. 9700066-5.

The reliability of the system can be improved by providing a protected object in the system with two or more markers 13a-13c, which allows preventing false alarm if one of the markers is hidden, disturbed or is invisible for a camera, the remaining markers can be discovered.

The system according to the invention can be made completely self-calibrating and very easy to install. The system can be arranged so that it indicates that if the markers are shown with sufficient intensity in itself. The influence of operation on the measuring values can be easily eliminated in the monitoring computer, since all the markers are moved in the same way.

The markers are preferably comprised of recessed or punched parts of self-adhering reflex tape to a low cost. However, the markers can be replaced by reflections 13d from the surfaces of the objects if a fixed or defined illumination is arranged.

If the protected object can be set in motion, for instance through vibration, a tolerance area is defined in the monitoring computer, so that no alarm is generated as long as the object is within the tolerance area.

“False” markers can eventually appear if there are many bright objects in an image, which the camera apprehends as a reflex mark. False markers can be filtrated in most of the cases by means of that the measuring system contains information concerning the shape of each mark. The false markers, which eventually remain after the filtration, are no problem since they are in fact stationary. Varying strong sunlight may cause problem through dazzling the system, but by means of appropriate camera location, such problems can be eliminated.

The system also provides possibility for protecting encased objects in, for instance in transparent spaces such as display cabinets or the like, without the need for wire laying in the space etcetera.

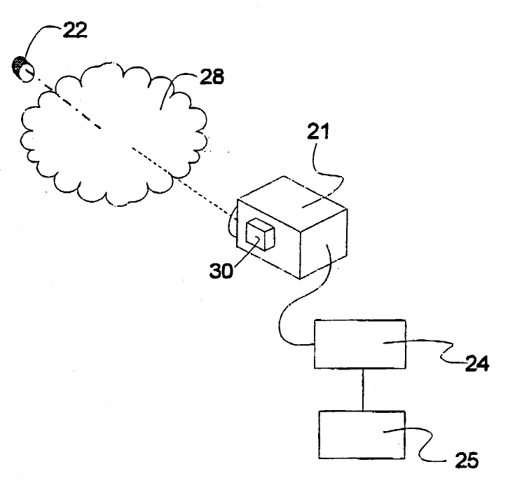

In another embodiment of the system 20, as shown in FIG. 2, the camera 21 also measures, in addition to the position of the marker, the light intensity received from the marker 22. In this case a disturbance in the measurement, for instance because of a cloud of smoke 26 can be detected by the computer as the light intensity becomes weaker. When the clouds of smoke are detected, for instance a fire alarm may be generated. The system can use coordinate values for detecting the marker and calculating its light intensity.

The system may also comprise communication means 15, 25, which in alarm mode sends a message to an alarm central or predetermined receivers. The system can also be connected to a network, such as Internet, for remote control and remote monitoring.

Moreover, the system according to the invention may be completed with a sensor 30 for heat detection.

While we have illustrated and described the preferred embodiments of the invention, it is realized that several variations, modifications or combinations of the embodiments within the scope of the appending claims may exist.

Reference Signs

10, 20 System

11, 21 Camera

12 Object

13, 23 Mark

14, 24 Computer unit

15, 25 Communication unit

16 Memory unit

28 Smoke

20 Heat detector

1. A monitoring system (10, 20) for monitoring at least one fixed but displaceable object in a volume, which object is provided with at least one marking means (13, 13a-13d, 23) in form of a light generating or representing device, which system at least comprises an optical recording unit (11, 21) for recording an image of at least a part of the volume comprising said object provided with the marking means (13, 13a-13d, 23), device for transferring said image to, a digital representation of the same image, means (14) for comparison of the digital representation to a stored data-set, and device for generating a signal at the presence of a deviation at the comparison of the digital representation with the stored data set,
characterized in
that the stored data-set at least comprises a two dimensional stationary coordinate value for the initial position of the marking means (13, 13a-13d), that the system comprises means for extracting at least a stationary coordinate value, which is at least a two-dimensional coordinate value, out of the digital representation of the marking means, whereby said comparison means (14) compares said extracted two-dimensional coordinate value with the stored stationary coordinate value.

2. A monitoring system (20) as claimed in claim 1,
characterized in
that said object is monitored for uncontrolled displacement.

3. A monitoring system (10) as claimed in claim 1 and 2,
characterized in
that the object is provided with a reflecting marker.

4. A monitoring system (10) as claimed in claim 2 and 3,
characterized in
that a part of the object is used as marking means.

5. A monitoring system (10) as claimed in claim 1-4,
characterized in
that several marking means are arranged on the same object.

6. A monitoring system (20) as claimed in claim 1,
characterized in
that the light intensity of the marking means is also measured.

7. A monitoring system (20) as claimed in claim 6,
characterized in
that the stored data set comprises an initial light intensity.

8. A monitoring system (20) as claimed in claim 6 or 7,
characterized in
that the system is intended as a fire alarm.

9. A monitoring system (20) as claimed in any of the preceding claims,
characterized in
that the system in addition comprises a heat detector.

10. A method for monitoring an object in an volume provided with at least a marking means (13, 13a-13d, 23) in form of a light generating or reflecting device, whereby the method comprises the steps of:
at least arranging one optical sensor unit (11, 21) for recording an image of at least one part of the volume comprising said marking means (13, 13a-13d, 23),
transforming said image to a digital representation of the same image,
comparing the digital representation to a stored data-set,
characterized in
that the method comprises the steps:
at least extracting one coordinate value, which is at least a two-dimensional coordinate value, out of the digital representation of the marking means,
comparing said extracted two-dimensional coordinate value to a stored stationary coordinate value for said marking means by means of said comparison means (14), and
generating a signal at the presence of a deviation at comparison of the extracted coordinate value to the stored coordinate value.

11. A method as claimed in claim 10,
characterized in
that the data comprises a value of the light intensity for said marking means as well.
